(19) United States
(12) Patent Application Publication
(10) Pub. No.: US 2019/0238920 A1
(43) Pub. Date: Aug. 1, 2019

(54) ALL-IN-ONE-DEVICE

(71) Applicant: Helen Huang, Vancouver (CA)

(72) Inventor: Helen Huang, Vancouver (CA)

(21) Appl. No.: 16/318,491

(22) PCT Filed: Aug. 5, 2016
(86) PCT No.: PCT/CA2016/050925

§ 371 Date: Jan. 17, 2019

(51) Int. Cl. H04N 21/41; H04N 21/478

(52) U.S. Cl. CPC H04N 21/4131; H04N 21/478; H04N 21/4113

(57) ABSTRACT

An all-in-one device including a plurality of hardware components integrated directly into the all-in-one device. The plurality of hardware components include television hardware components configured to perform at least one television functionality and consumer device hardware components configured to perform at least one consumer device functionality. The at least one consumer device functionality is different from the at least one television functionality. The all-in-one device further includes at least one processor configured to direct the television hardware components to perform the at least one television functionality and the consumer device hardware components to perform the at least one consumer device functionality such that both the at least one television functionality and the consumer device functionality is performed directly by the all-in-one device.

### 1.0 FIELD

This disclosure relates generally to an all-in-one device.

### 2.0 BACKGROUND

Using separate consumer devices which each perform a single or a limited set of functions can be cumbersome, due to the need to locate separate consumer devices, carry separate consumer devices, charge separate consumer devices, update software of separate consumer devices, etc. Although some consumer devices are multi-functional in the sense that they integrate certain functionalities, these functionalities may still be limited.

Further, separate consumer devices may require separate setup in order to communicate with each other. Further still, consumer devices which are connected to power outlets and networks through wires may clutter a home.

### SUMMARY

In one embodiment, there is provided an all-in-one device including a plurality of hardware components integrated directly into the all-in-one device. The plurality of hardware components include television hardware components configured to perform at least one television functionality and consumer device hardware components configured to perform at least one consumer device functionality. The at least one consumer device functionality is different from the at least one television functionality. The all-in-one device further includes at least one processor configured to direct the television hardware components to perform the at least one television functionality and the consumer device hardware components to perform the at least one consumer device functionality such that both the at least one television functionality and the consumer device functionality is performed directly by the all-in-one device.

### DESCRIPTION OF THE FIGURES

FIG. 1 is a perspective view of an all-in-one device according to an illustrative embodiment;

FIG. 2 is a back elevation view of the all-in-one device of FIG. 1;

FIG. 3 is a side elevation view of the all-in-one device of FIG. 1;

FIG. 4 is a schematic of a communication environment of the all-in-one device of FIG. 1 within a home of a user;

FIG. 5 is a schematic view of the all-in-one device of FIG. 1;

FIG. 6 is a viewing interface defined by user interface codes of the all-in-one device of FIG. 5;

FIG. 7 is a control center interface defined by user interface codes of the all-in-one device of FIG. 5; and

FIG. 8 is home device program codes in a program memory of the all-in-one device of FIG. 5.

### DETAILED DESCRIPTION

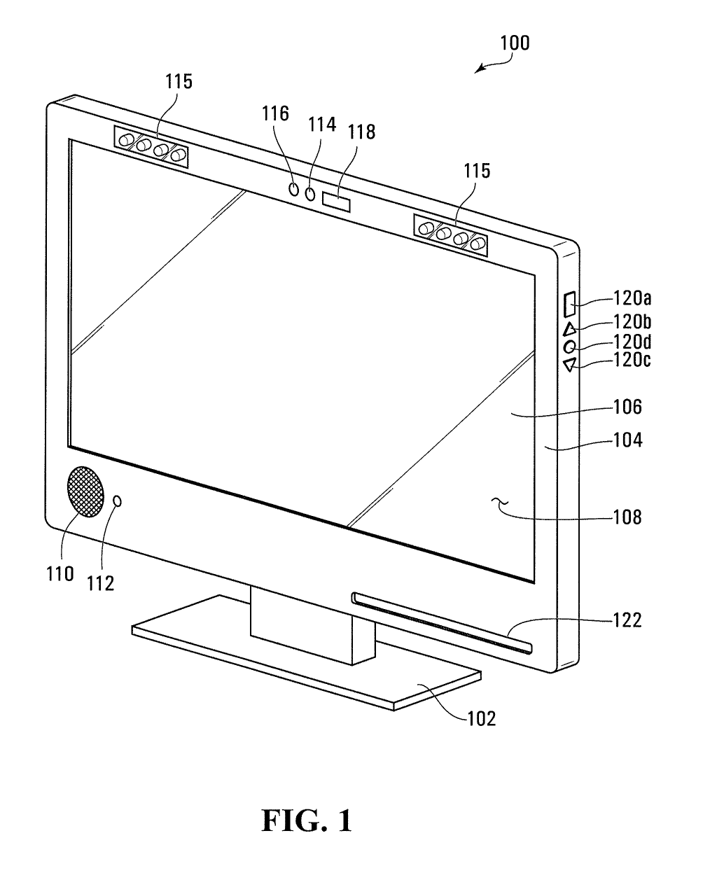

Referring to FIG. 1, an all-in-one (“AIO”) device according to an embodiment is shown generally at 100. In the embodiment shown, the AIO device is a television 100 and includes one or more components of “a smart television”. A smart television generally refers to television set capable of receiving traditional cable media as well as content distributed over the internet, and represents a combination of personal computers and television sets. In the embodiment shown, the AIO television 100 also includes one or more hardware components of common consumer devices used within a home of a user directly integrated into the AIO television 100, such as hardware components of a printer, scanner, copier, telephone, camera, lighting systems, and a security system. In other embodiments, the AIO television 100 may be any network-enabled telecommunication device and may include additional hardware components of other common consumer devices.

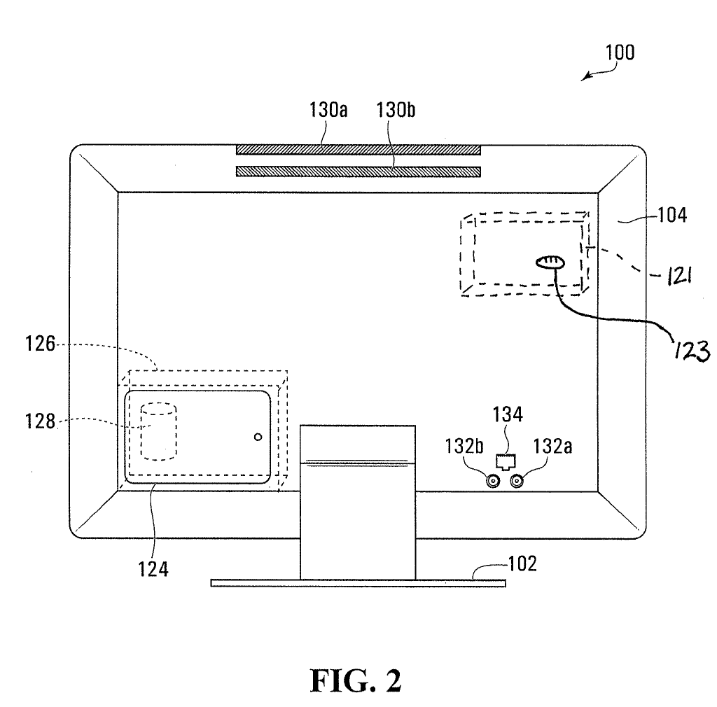

In the embodiment shown, the AIO television 100 is supported by a stand 102 which is attached to a frame 104 of the AIO television 100. In other embodiments, rather than the stand 102, the frame 104 can include one or more mounting points on a rear of the frame 104 (shown in FIG. 2) to facilitate mounting of the AIO television 100 to a vertical surface, such as a wall, for example. In other embodiments, the AIO television 100 may be hand-held such that it is not supported by the stand 102 nor mounted on a surface and may be carried and moved around by a user of the AIO television 100 within a home of the user.

In the embodiment shown, the frame 104 supports a display screen 106 configured to display television programming content provided to the AIO television 100, and/or content provided by other home devices connected to the AIO television 100. In some embodiments, the display screen 106 may compromise a liquid crystal display screen, a plasma screen, a light emitting diode screen, or other screen types. In the embodiment shown, an entire front surface 108 of the display screen 106 is touch sensitive and capable of receiving input by a user directly touching the front surface 108 or by the user touching the front surface 108 using a touch screen pen (not shown). For example, the display screen 106 may display a touch screen keyboard, which may be actuated by the user touching the front surface 108 directly or with the touch screen pen. In some embodiments, the AIO television 100 include at least one of an infrared and radio frequency transreceiver (not shown) and may be controlled by a remote control emitting infrared or radio frequency signals.

The AIO television 100 further includes at least one integrated speaker 110, at least one integrated microphone 112 and at least one integrated image capture device 114, such as a front-facing camera, for example. The integrated image capture device 114 may be associated with additional hardware elements of the AIO television 100, such as an integrated flash or other light source 116 and an integrated range finding device 118 to assist in zooming and focusing of the integrated image capture device 114. In some embodiments, the integrated image capture device 114 may be mounted on rotating means (not shown) such that the integrated image capture device 114 may be rotated relative to the frame 104 to capture panoramic images.

The AIO television 100 further includes a plurality of integrated lighting devices 115, which may each be individually controlled to emit light beams of different colour and brightness. The integrated lighting devices 115 may be light-emitting diode bulbs, for example. The integrated lighting devices 115 may each be further associated with additional hardware elements of the AIO television 100, such as a rotating means (not shown), for rotating the plurality of integrated lighting devices 115 relative to the frame 104 to provide directional lighting.

The AIO television 100 further includes an integrated printer 122 which may be configured to print a physical representation of an image or a document displayed on the display screen 106. Referring to FIG. 2, the AIO television 100 further includes an integrated scanner and copier 124, which may be configured to scan a physical document of one or more pages into a digital format and to copy a physical document of one or more pages into a copied physical document. The integrated printer 122 and the integrated scanner and copier 124 may be associated with additional hardware elements of the AIO television 100, such as a paper tray 126 to hold paper for the printing and the copying, and toner 128 for supplying ink for the printing and the copying. In the embodiment shown, the integrated printer 122 is located on a front of the AIO television 100 and the integrated scanner and copier 124 is located on the rear of the AIO television 100, although the integrated printer 122 and the integrated scanner and copier 124 may be located at other locations.

As described above, in the embodiment shown, the AIO television 100 includes a variety of hardware components associated with home consumer devices. However, it is anticipated that, in alternative embodiments, the AIO television 100 may further include other hardware components integrated directly into the AIO television 100 to enable the AIO television 100 to perform further functionalities. For example, the AIO television may further integrate hardware components to enable the AIO television to perform functionalities associated with GPS navigation, heart-rate monitoring, body-weight monitoring, sleep-cycle monitoring, etc. In other embodiments, the AIO television may further integrate hardware components associated with controlling a temperature of a home of a user, such as an integrated electric thermometer, for example, to enable the AIO television to perform integrated home temperature control functionalities. In other embodiments, the AIO television may further integrate hardware components associated with an alarm control and alerting device of a home alarm system, for example, to enable the AIO television to perform integrated alarm functionalities.

Referring back to FIG. 1, the AIO television 100 further includes buttons 120 configurable for specific inputs to control the AIO television 100 located on a side of the AIO television 100, although the buttons 120 may be placed at other locations on the AIO television 100. In the embodiment shown, the AIO television 100 includes a power button 120a configured as an on/off button used to control overall system power to the AIO television 100, and an increase button 120b, a decrease button 120c and a control button 120d configured to control a number of aspects of the AIO television 100, such as system volume emitted by the integrated speaker 110, brightness of the display screen 106, the integrated image capture device 114, the integrated lighting devices 115, the integrated microphone 112, the integrated printer 122, the integrated scanner and copier 124, etc.

Referring back to FIG. 2, the AIO television 100 further includes an internal rechargeable battery 121 and a charge port 123 for transferring power from a power source to the rechargeable battery 121. In the embodiment shown, the charge port 123 is located on the rear of the AIO television 100, although in other embodiments, the charge port 123 may be located in other locations. The rechargeable battery 121 stores and then supplies power to the AIO television 100, and in certain embodiments, enable the AIO television 100 to be powered without being connected to the power source. In such embodiments, the AIO television 100 may be wirelessly used around the home.

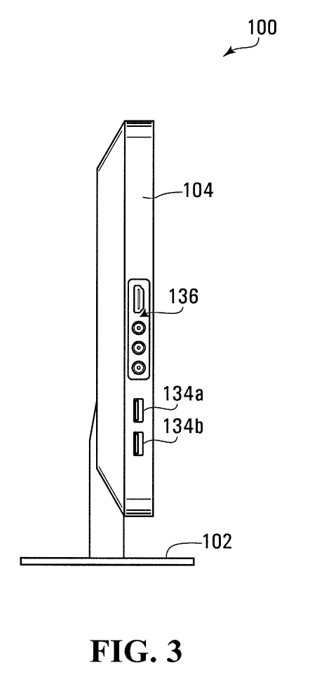

Referring to FIGS. 2 and 3, the AIO television 100 includes a variety of communication interfaces configured to support the communication functions of the AIO television 100. In the embodiment shown in FIG. 2, the AIO television 100 includes antennae 130a and 130b, connection ports 132a and 132b, and a telephone line jack 134 located on the rear of the AIO television 100, although in other embodiments, they may be located at other locations on the AIO television 100.

The antennae 130a and 130b may be interfaces configured to enable the AIO television 100 to receive signals wirelessly from a service provider or other network devices. For example, the antennae 130a may be configured to receive digital and/or analog broadcast signals from a service provider transmitted over an external network, for example, and the antenna 130b may be configured to receive signals from home devices within the home of the user transmitted over an internal network. Specifically, in some embodiments, the antenna 130b may be configured to enable the AIO television 100 to be connected to additional input devices wirelessly, such as a Bluetooth™ enabled keyboard or a Bluetooth™ mouse.

The connection ports 132a and 132b may be interfaces for connecting the AIO television 100 to an external network of a service provider, such as the internet, using wired means. The connector ports 132a and 132b may be configured to enable to AIO television 100 to receive a digital subscriber line, an optical fiber line, an Ethernet line or other similar networking cables. The telephone line jack 134 may be an interface configured to further enable the AIO television 100 to communicate over an external network, such as a telephone network, using wired means.

Referring now to FIG. 3, in the embodiment shown, the AIO television 100 further includes docking ports 134a and 134b located on a side of the AIO television 100, although in other embodiments, they may be located in other locations. The docking ports 134a and 134b may be interfaces configured to enable the AIO television 100 to be connected to other devices or components for data transfer, power transfer, etc. For example, the docking ports 134a and 134b may include proprietary or universal receptacles to receive connectors such as a USB connector, for example. The AIO television 100 further includes an audio/video (“AV”) I/O module 136 located on the side of the AIO television, although in other embodiments, the AV I/O module 136 may be located in other locations. The AV I/O module 136 may be an interface configured to enable the AIO television 100 to receive audio/visual signals from other devices which generates AV signals. For example, the AV I/O module 136 may include receptacles to receive an RCA connector, a HDMI connector, or other such connectors.

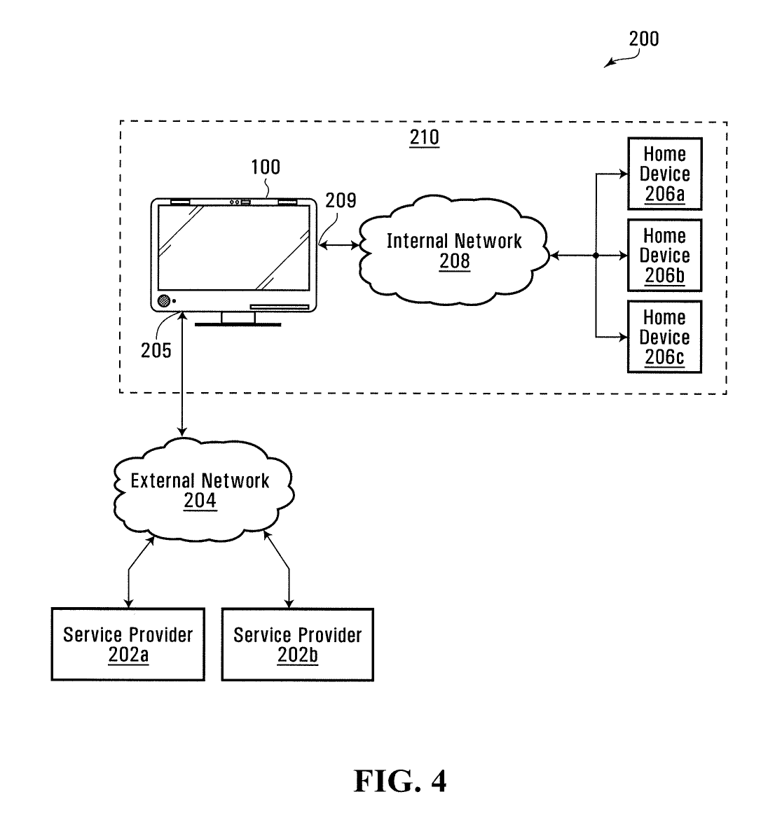

Referring to FIG. 4, a communication environment of the AIO television 100 within a home 210 of a user is shown generally at 200. In the embodiment shown in FIG. 4, the communication environment 200 includes the AIO television 100 connected to service providers 202 and home devices 206 through an external network 204 and an internal network 208, respectively. In other embodiments, the AIO television 100 may be connected to more than two service providers or only a single service provider, may be connected to more than three home devices or less than three home devices, may be connected to different home devices over different internal networks, and may be connected to different service providers over different external networks.

As described above, the AIO television 100 includes a variety of communication interfaces. These communication interfaces enable the AIO television 100 establish network connections with the service providers 202 and the home devices 206 through wired connections (such as through the connection ports 132a and 132b, the docking ports 134a and 134b, the telephone line jack 134, and the AV I/O module 136, for example) and wireless connections (such as through the antenna 130a and 130b, for example).

The communication interfaces of AIO television 100 generally include an external network interface 205 (examples of which may include the connection ports 132a and 132b, the telephone line jack 134 and the antenna 130a) to enable the AIO television 100 to communicate data to and receive data from the service providers 202 through the external network 204 through either wired or wireless means. The service providers 202 may include one or more server devices capable of providing information resources. For example, service provider 202a may include video content providers (i.e. television providers, video-on-demand (VOD) providers, over-the-top (OTT) content providers, etc.) and internet service providers, for example. Service provider 202b may include telephone service providers, for example. The external network 204 is generally configured to connect the AIO television 100 to the service providers 202 located outside of the home 210 and may include a local area network (LAN), a wireless local area network (WLAN), a wide area network (WAN), a cellar network, a Wi-Fi network, an intranet, the Internet, an optical fiber-based network, or a combination thereof.

The communication interfaces of the AIO television 100 generally further include an internal network interface 209 (examples of which may include the antenna 130b, the docking ports 134a and 134b, and the AV I/O module 136) to enable the AIO television 100 to communicate data to and receive data from various home devices 206a, 206b and 206c through the internal network 208 through either wired or wireless means. The home devices 206a, 206b and 206c may include security systems (such as remote security cameras, remote audio intercoms and home alarm systems), lighting systems, door controllers, thermostats, refrigerators, stoves, ovens, microwaves, dishwashers, clothing washers, clothing dryers and various other home consumer appliances. The internal network 208 is generally configured to connect the AIO television 100 to home devices 206 located within the home 210 and may be a network functional across a shorter distance, such as a Wi-Fi network, a LAN, a WLAN, or a combination thereof. Furthermore, the internal network 208 may be configured to connect the AIO television 100 with other AIO televisions, such as if a home of the user has more than one AIO television 100, for example.

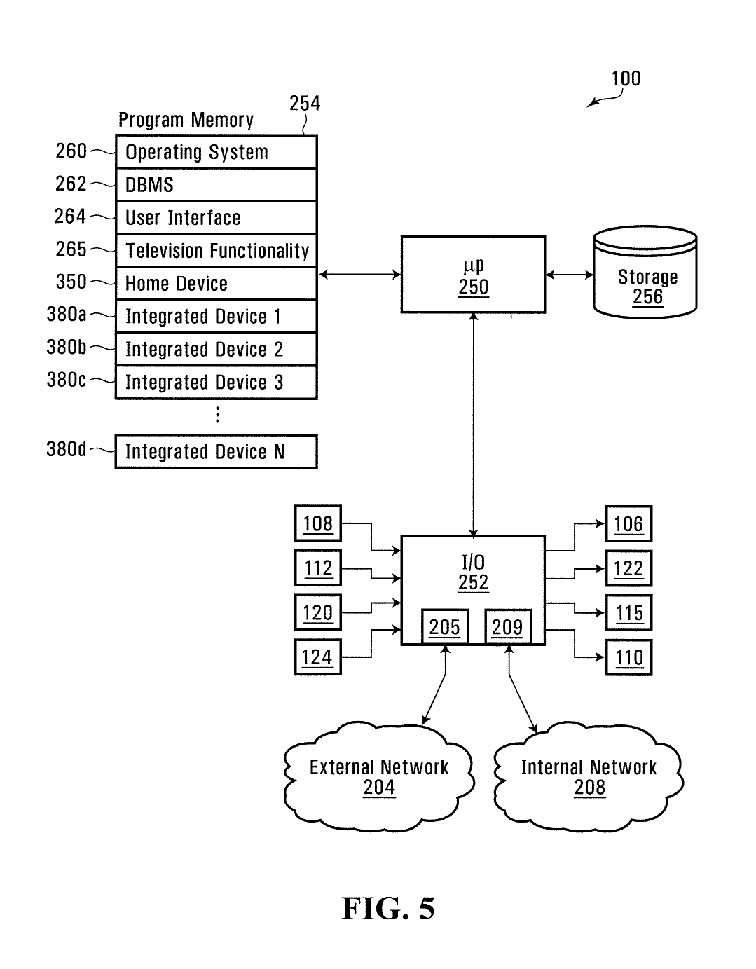

Referring to FIG. 5, the AIO television 100 includes a processor circuit, which in the embodiment shown, includes a microprocessor 250, an input/out (“I/O”) interface 252, a program memory 254, and a storage memory 256, all in communication with the microprocessor 250.

The microprocessor 250 generally functions to run programming instructions implementing various functions of the AIO television 100 stored in the program memory 254. In at least some embodiments, the microprocessor 250 may include at least one of multiple processor cores and multiple physical processors. In other embodiments, the microprocessor 250 may include a specially configured application specific integrated circuit (ASIC) or other integrated circuit, a digital signal processor, a controller, a hardwired electronic or logic circuit, or a programmable logic device or gate array, for example.

The I/O interface 252 includes input signal interfaces that facilitate receipt of input signals from input devices (examples of which include at least the front surface 108, the integrated microphone 112, the buttons 120a-120d, and the integrated scanner and copier 124 in the embodiment shown in FIGS. 1-3, for example), output interfaces that facilitate generation of output signals to control the display screen 106, the integrated printer 122, the integrated lighting devices 115, the integrated image capture device 114, and the integrated speaker 110, and the network interfaces 205, 209 to facilitate communication using the external network 204 and the internal network 208 as previously described. The program memory 254 and the storage memory 256 may be implemented on the same or different ones of, or on a combination of more than one of, a random access memory (“RAM”), a hard disk drive (“HDD”), and other computer-readable and/or -writable memory. The storage memory 256 may have at least one terabyte of disk drive capacity, for example.

The program memory 254 stores executable program codes for directing the microprocessor 250 to execute various functions of the AIO television 100. The program memory 254 stores various blocks of codes, including operating system codes 260 of an operating system for the AIO television 100. In some embodiments, the operating system codes 260 may implement a Microsoft Windows™ operating system, an iOS™ operating system, an Android™ TV operating system, for example. The operating system codes 260 generally allow software installed in the AIO television 100 to interact with hardware associated with the AIO television 100 and may include various device drivers which operates and controls particular hardware components integrated with the AIO television 100, such as the display screen 106, the integrated speaker 110, the integrated microphone 112, the integrated lighting devices 115, the integrated printer 122 and the integrated scanner and copier 124, for example and particular hardware components that may be connected to the AIO television 100, such as the home devices 206, for example.

The program memory 254 also includes database management system (“DBMS”) codes 262 for managing the storage memory 256. For example, the DBMS codes 262 may allow a user of the AIO television 100 to store data such as video files, audio files, multimedia files, etc. in the storage memory 256 for later projection using the AIO television 100, such as through the display screen 106 or the integrated speaker 110, for example.

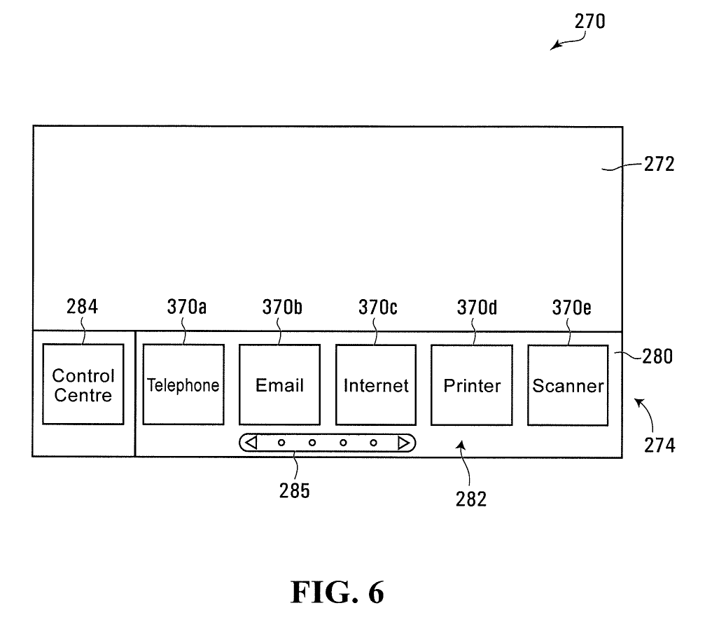

The program memory 254 also includes user interface codes 264, which establishes and controls various user interfaces of the AIO television 100 to enable the user of the AIO television 100 to interact with the AIO television 100. For example, the user interfaces implemented and controlled by the user interface codes 264 may include the viewing interface shown generally at 270 in FIG. 6, for example.

In the embodiment shown in FIG. 6, the viewing interface 270 includes a television viewing area 272 which may include an area to present video content and related information for general television viewing. For example, the television viewing area 272 may display video content, such as a broadcast television program or streaming video, for example. The television viewing area 272 may also include tuning information, such as a channel number, network name, and/or program name for a particular program selected by the user. A size of the television view area 272 may be adjustable such that the television viewing area 272 may be expanded to encompass the entire area of the viewing interface 270 and the entire area of the display screen 106, for example.

To enable AIO television 100 to perform television functionalities, the program memory 254 may include television functionality program codes 265 (shown in FIG. 5). When the AIO television 100 is turned on, such as by actuation of the on/off button 120a by the user of the AIO television 100, the television functionality program codes 265 may cause the microprocessor 250 of the AIO television 100 to receive, at the external network interface 205, television signals from a service provider, such as the service provider 202a, through the external network 204. The television functionality program codes 265 may then cause the microprocessor 250 to convert the received television signals into video signals for display on the display screen 106 and audio signals for projection through the speaker 110, such as by decoding and/or decompressing the received television signals. The television functionality program codes 265 may then cause the microprocessor 250 to direct the video signals to be displayed in the display screen 106, such as in the television viewing area 272, for example, and the audio signals to be projected through the integrated speaker 110.

In some embodiments, the television functionality program codes 265 may cause the microprocessor 250 direct broadcast programs to be recorded and may cause the microprocessor 250 to store the recorded broadcast programs in the storage memory 256 for later viewing. In some embodiments, the television functionality program codes may direct the microprocessor 250 to communicate, at the internal network interface 209, with home devices 206 configured to transmit multimedia signals, such as BluRay™ players and DVD players, and may further direct the microprocessor 250 to receive and play the transmitted multimedia signals.

In certain embodiments, television functionalities of the AIO television 100 may include displaying video on the display screen 106 and projecting audio through the integrated speaker 110 based on multi-media signals received from traditional broadcast media service providers, internet content providers, connected home devices 206 which transmit multi-media signals, devices integrated into the AIO television 100 which transmit multi-media signals, video-on-demand providers, over-the-top content providers, and other similar content providers. In some embodiments, the television functionalities of the AIO television 100 may include displaying video on the display screen 100 without projecting audio through the integrated speakers 110, and in other embodiments, the television functionalities of the AIO television 100 may include projecting audio through the integrated speakers 110 without displaying video on the display screen 106.

The viewing interface 270 may further include a functionality selection area 274. The functionality selection area 274 generally includes a dashboard 280 having functionality tiles 282 each of represent a home device control functionality of the AIO television 100 (for example, functionalities related to utilizing the AIO television 100 to control home devices 206 connected to the AIO television, for example) or an integrated functionality of the AIO television 100 (for example, functionalities related to control of integrated hardware components of the AIO television 100, such as the integrated speaker 110, the integrated microphone 112, the integrated image capture device 114, the integrated lighting devices 115, the integrated printer 122, the integrated scanner and copier 124, and applications installed in the program memory 254 of the AIO television 100, for example), which will be described in greater detail below. The functionality selection area 274 further includes a scroll bar 285 for scrolling through the functionality tiles 282.

In the embodiment shown, the functionality selection area 274 is shown as a portion of the viewing interface 270, however, in other embodiments, the functionality selection area 274 may be re-sizeable or may encompass the entire area of the viewing interface 270 and the entire area of the display screen 106, for example.

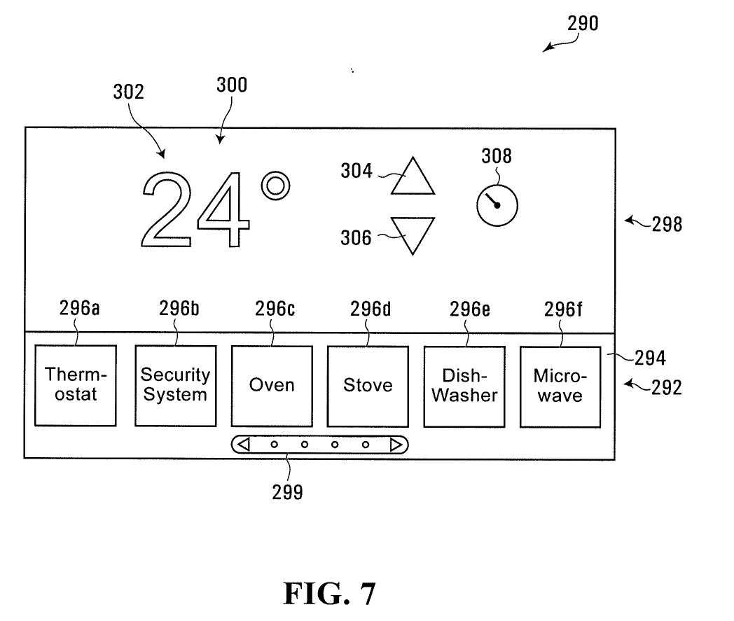

In the embodiment shown in FIG. 6, the functionality tiles 282 include a control center functionality tile 284. When the control center functionality tile 284 is selected by a user of the AIO television 100 through user input by actuation of at least one input device of the AIO television 100, such as the front surface 108 of the display screen 106, for example, the user interface codes 264 may cause the microprocessor 250 to direct the display screen 106 to display a control center interface shown generally at 290 in FIG. 7. In some embodiments, the user interface codes 264 may cause the control center interface 290 to be displayed in other manners, such as in the television viewing area 272 of the viewing interface 270, for example.

Referring to FIG. 7, the control center interface 290 includes a home device selection area 292 including a dashboard 294 having home device functionality tiles 296, each of which may be selected by the user to control a home device 206 connected to the AIO television 100 at the internal network interface 209 through the internal network 208 (shown in FIG. 5). In the embodiment shown, the home device functionality tiles 296 include a thermostat tile 296a, a security system tile 296b, an oven tile 296c, a stove tile 296d, a dishwasher tile 296e and a microwave tile 296f In other embodiments, the AIO television 100 may be connected, at the internal network interface 209 through the internal network 208, to other home devices 206, such as a door controller, a clothing washer, a clothing dryer, home lighting systems, DVD players, BluRay™ players, personal computers, external printers, gaming consoles, for example, and in such embodiments, the dashboard 294 may include home device functionality tiles 296 corresponding to these additional home devices 206. In other embodiments, the AIO television 100 may be connected, through the internal network interface 209, to only a few home devices 206, and in such embodiments, the dashboard 294 may only include home device functionality tiles 296 representing those few home devices 206 connected to the AIO television 100. The home device selection area 292 further includes a scroll bar 299, which can be used to scroll through the various home device functionality tiles 296.

The control center interface 290 further includes a control area 298. When one of the home device functionality tiles 296 is selected, such as by a user selection signal generated by the user actuating the front surface 108, the user interface codes 264 may cause the microprocessor 250 to display, in the control area 298, information received from and command options for controlling the home device associated with the selected home device functionality tile 296, as will be described in greater detail below.

Referring now to FIGS. 5, 6 and 8, in one embodiment, user selection of one of the home device functionality tiles 296 causes the microprocessor 250 to execute home device program codes 350 that are stored in the program memory 254 (shown in FIG. 5) and that direct the microprocessor 250 to receive information from the home devices 206, display information and command options for controlling the home devices 206, and send commands to the home devices 206.

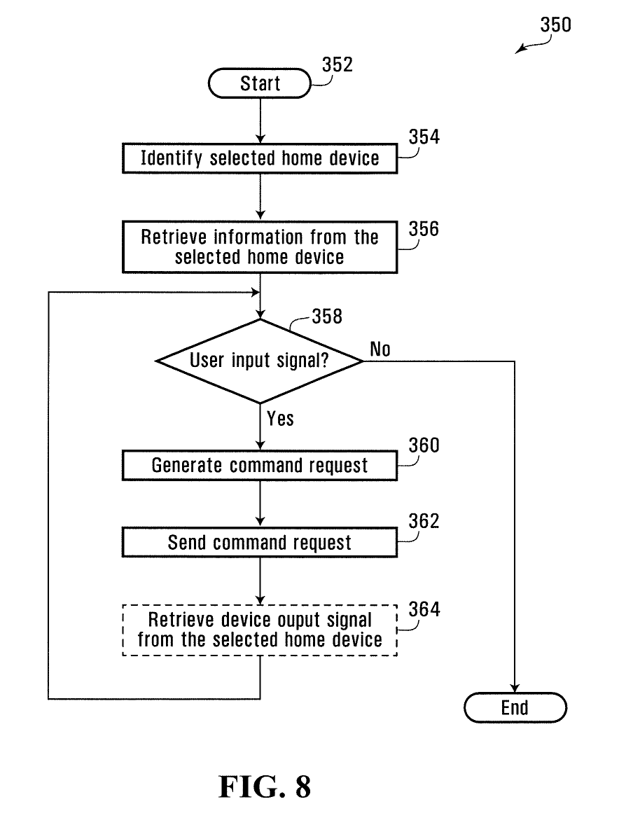

Referring to FIG. 8, the home device program codes 350 begin at 352 in response to receiving signals indicating user selection of one of the home device functionality tiles 296. The home device program codes 350 then continue to 354, which includes codes for directing the microprocessor 250 to identify the home device 206 associated with the selected home device functionality tile 296.

For example, in the embodiment shown in FIG. 7, if the thermostat tile 292a selected, the codes at block 354 may cause the microprocessor 250 to identify a thermostat connected to the AIO television 100 as the selected home device. In other embodiments, if the security system tile 296b is selected, the codes at block 354 may cause the microprocessor 250 to identify remote security cameras, remote audio intercoms and home alarm systems connected to the AIO television 100 as the selected home devices. In yet other embodiments, if the dishwasher functionality tile 296e is selected, the codes at block 354 may cause the microprocessor 250 to identify a dishwasher connected to the AIO television 100 as the selected home device.

The home device program codes 350 then continue to block 356, which include codes for directing the microprocessor 250 to retrieve information from the selected home device 206, which may include data information captured by the selected home device, as well as information representing preset command options for controlling the selected home device. The user interface codes 264 may then direct the microprocessor 250 to display, on the display screen 106, the retrieved information and command options in the control area 298.

For example, in the embodiment shown in FIG. 7, the codes at block 356 causes the microprocessor 250 to retrieve information measured by the thermostat, such as a current temperature of the home of the user measured by the thermostat for example, and command options associated with controlling the thermostat, such as command options for increasing and decreasing a desired temperature of the home of the user and input options for scheduling desired temperatures through a 24-hour period, for example. In other embodiments, the thermostat may measure and provide different information, such as information identifying a specific room of the home, and the thermostat may further have other preset command options, such as toggling a vacation mode or an energy saving mode for example.

The user interface codes 264 then cause the microprocessor 250 to display a thermostat interface shown generally at 300 in FIG. 7 in the control area 298, the thermostat interface 300 including representations of the information retrieved from the thermostat at block 356. In the embodiment shown, the thermostat interface 300 includes a measured temperature area 302, which displays the current temperature data captured by and retrieved from the thermostat. The thermostat interface 300 also includes an increase command option 304, a decrease command option 306, and a timer command option button 308, each of which represent command options for controlling the thermostat retrieved from the thermostat.

In other embodiments, if another home device functionality tile 296 is selected, the information and command options retrieved by the microprocessor 250 in response to the codes at block 356 may be different and the information and command options displayed by the microprocessor 250 on the display screen 106 in response to the user interface codes 264 may be correspondingly different.

For example, if the security system functionality tile 296b (shown in FIG. 7) is selected, the codes at block 356 may cause the microprocessor 250 to retrieve feeds from the remote security cameras and the remote audio intercoms connected to the AIO television 100 and retrieve a status indication from the home alarm systems connected to the AIO television 100. The codes at block 356 may further cause the microprocessor 250 to retrieve command options for controlling the remote security cameras (such as a field of view), the remote audio intercoms (such as on/off) and the home alarm systems (such as arming/disarming). The user interface codes 264 may then direct the microprocessor 250 to display, in the control area 298 of the control center interface 290, a security system interface displaying the feeds of the remote security cameras and the status indication of the alarm systems. The user interface codes 264 may further direct the microprocessor 250 to project, through the integrated speaker 110, the feeds of the remote audio intercoms. The user interface codes 264 may further direct the microprocessor 250 to display, on the security system interface, command options for controlling the security cameras, audio intercoms and alarm systems.

As a further example, if the dishwasher tile 296e (shown in FIG. 7) was selected, the microprocessor 250 may be caused, by the codes at block 356, to retrieve information indicating the current status of the dishwasher, such as whether the dishwasher is on or off and such as whether the dishwasher is fully loaded with dishes, half-loaded with dishes, or empty, for example. The microprocessor 250 may further be caused, by the codes at block 356, to retrieve command options associated with controlling the dishwasher, such as command options for selecting a wash cycle, starting a wash cycle, and setting a wash temperature, for example. The user interface codes 264 may then direct the microprocessor 250 to display, in the control area 298 of the control center interface 290, a dishwasher interface displaying representations of the current status of the dishwasher and the command options for controlling the dishwasher.

The home device program codes 350 then continue to block 358, which includes codes for directing the microprocessor 250 to determine whether a user input signal representing an indication by the user to control the identified home device is generated. The user input signal may be generated by actuation of one of the command options displayed on the display screen 106 by the user actuating at least one input device of the AIO television 100, such as the front surface 108 of the display screen 106, for example. In the embodiment shown FIG. 7, a user input signal may be generated when a user actuates the increase command option 304, the decrease command option 306 or the timer command option 308 displayed on the thermostat interface 300.

If the user does not generate a user input signal, the home device program codes 350 are then ended. For example, a user may select one of the home device functionality tiles 296 to simply receive information about a home device 206 and not desire to actuate any command options associated with the home device 206.

If the user does generate a user input signal, the home device program codes 350 then continue to block 360, which includes codes for directing the microprocessor 250 to generate a command request in a format suitable for the selected home device 206. For example, in the embodiment shown in FIG. 7, if a user input signal is received due to user actuation of the increase command option 304, the codes at block 360 causes the microprocessor 250 generate an “increase temperature” command request. If a user input signal is received due to user actuation of the decrease command option 306, the code at block 360 causes the microprocessor 250 to generate a “decrease temperature” command request.

In other embodiments, if a user input signal is generated by actuation of a different command option, a correspondingly different command request may be generated. The home device program codes 350 then continue to block 362, which includes codes for causing the microprocessor 250 to send, through the internal network interface 209 and the internal network 208, the command request to the selected home device 206 to direct the identified home device to implement the command request. For example, in the embodiment shown in FIG. 7, if the codes at block 362 cause the microprocessor 250 to send the “increase temperature” command request to the thermostat, the thermostat may be caused to actuate a heating device in the home in response to the “increase temperature” command request, for example. Similarly, if the codes at block 362 cause the microprocessor 250 to send the “decrease temperature” command request to the thermostat, the thermostat may be caused to actuate a cooling device in the home in response to the “decrease temperature” command request, for example.

The home device program codes 350 may then continue to an optional block 364, which includes codes for causing the microprocessor 250 to retrieve a device output signal from the selected home device 206, the device output signal representing an indicating from the selected home device 206 that that the command request was implemented by the selected home device 206. The user interface codes 264 may then cause the microprocessor 250 to display, on the display screen 106, a representation of the device output signal. For example, in the embodiment shown in FIG. 7, if a command request based on actuation of the increase command option 304 or the decrease command option 306 was sent from the microprocessor 250 to the thermostat at block 362, the device output signal retrieved from the thermostat may be an indication of that the measured temperature, shown in the measured temperature area 302 for example, has increased or decreased. The user interface codes 264 may then direct the microprocessor 250 to display, in the control center interface 290, such the representing of this device output signal, such as by changing a temperature displayed in the measured temperature area 302, for example.

After completion of the optional block 364, the home device program codes 350 then return to block 358 to wait to determine whether another user input signal is generated by the user to control the selected home device. If no additional user input signal is generated, the home device program codes 350 are then ended.

Referring back to FIG. 6, the functionality tiles 282 may further include integrated functionality tiles 370 each of which may be selected to control an integrated functionality of the AIO television 100. Generally, integrated functionalities of the AIO television 100 include consumer device functionalities performed utilizing integrated hardware components of the AIO television 100 (such as the integrated speaker 110, the integrated microphone 112, the integrated image capture device 114, the integrated lighting devices 115, the integrated printer 122, and the integrated scanner and copier 124, for example) and software applications installed in the AIO television 100 (such as on the program memory 254, for example).

In certain embodiments, the consumer device functionalities of the AIO television 100 are different from the television functionalities of the AIO television 100. Specifically, the consumer device functionalities may be different from displaying video on the display screen 106 and projecting audio through the integrated speaker 110 based on received multi-media signals.

In the embodiment shown in FIG. 6, the integrated functionality tiles 370 include an integrated telephone tile 370a, an integrated email tile 370b, an integrated internet tile 370d, an integrated printer tile 370d and an integrated scanner tile 370e. In other embodiments, the integrated functionality tiles 370 may include other integrated functionalities of the AIO television 100, such as an integrated lighting tile, an integrated image capture tile and other common consumer device functionality tiles associated with other consumer device hardware components which may be integrated into the AIO television 100.

Referring now to FIGS. 5 and 6, in one embodiment, user selection of one of the integrated functionality tiles 370 (shown in FIG. 6) causes the microprocessor 250 to execute at least one corresponding integrated device program codes 380 that are stored in the program memory 254 (shown in FIG. 5) and that direct the microprocessor 250 to implement at least one of the integrated functionalities of the AIO television 100, which will be described in greater detail below. The program memory 254 may store a plurality of integrated device program codes 380, each of which may correspond to desired integrated functionalities to be performed by the hardware elements integrated in the AIO television 100 and may further correspond to desired functionalities to be performed by software applications installed in the AIO television 100. In the embodiment shown in FIG. 5, the program memory 254 stores N-number of integrated device program codes 380a-d. In the embodiment shown in FIGS. 1-3, the AIO television 100 includes certain specific hardware components, such as the integrated printer 122, the integrated scanner and copier 124, the integrated lighting devices 115, the integrated image capture device 114, etc. However, it is anticipated that, in alternative embodiments, the AIO television 100 may further include a variety of other commonly known hardware components to enable the AIO television to perform further integrated functionalities. For example, the AIO television may further incorporate hardware components to enable the AIO television to perform functionalities associated with GPS navigation, heart-rate monitoring, body-weight monitoring, sleep-cycle monitoring, etc.

For example, one of the integrated device program codes 380 may be telephone program codes which includes codes for directing the microprocessor 250 to cause the AIO television 100 to perform integrated telephone functions, such as initiate and receive voice calls, video calls and text messages. A user may initiate the telephone program codes by selecting the integrated telephone tile 370a (shown in FIG. 6). In response to the selection of the telephone tile 370a, the microprocessor 250 may direct the external network interface 205 (such as the antenna 130a or the telephone line jack 134 of the AIO television 100, for example) of the AIO television 100 to communicate with a service provider 202, such as a telephone service provider 202b, over the external network 204, which may be a cellular network. In certain embodiments, the telephone program codes block may direct the microprocessor 250 to make and receive audio calls over the external network 204 using the integrated speaker 110 and the integrated microphone 112, and to make and receive video calls over the external network 204 by using the integrated image capture device 114, the display screen 106, the integrated speaker 110 and the integrated microphone 112. For example, the AIO television 100 may communicate with at least one other AIO television, in real-time, to receive and make video calls and video conferences. The telephone program codes may further direct the microprocessor 250 to send and receive text messages over the external network 204 using inputs generated by actuation of the front surface 108 and the display screen 106.

One of the integrated device program codes 380 may be email application program codes, which includes codes for directing the microprocessor 250 to cause the AIO television 100 to run an email application installed in the program memory 254 and configured to enable the AIO television 100 to perform general email functions such as composing, sending and receiving emails. For example, a user may initiate the email application program codes by selecting the integrated email tile 370b (shown in FIG. 6). The email application program codes may cause the microprocessor 250 to direct the display screen 106 to display a user interface of the email application for composing, sending and receiving email messages. For example, the email application program codes may cause the microprocessor 250 to direct the display screen 106 to display the user interface of the email application in the television viewing area 272. Further, the email application program codes may cause the microprocessor 250 to direct the external network interface 205 (such as the antenna 130a, the wired ports 132b and the telephone line jack 134, for example) components of the AIO television 100 to allow the AIO television 100 to communicate with a service provider, such as the internet service provider 202a, over the external network 204, such a LAN network, for example, to facilitate sending and receiving email.

One of the integrated device program codes 380 may be internet application program codes which includes codes for directing the microprocessor 250 to cause the AIO television 100 to run an internet browsing application installed in the program memory 254 and configured to enable the AIO television 100 to perform general internet browsing functions such as retrieving, presenting, and accessing information resources on the World Wide Web and intranet browsing functions. The internet browsing application may be, for example, a Google™ web browser, a Mozilla™ web browser, or an Apple™ web browser. A user may initiate the internet application program codes by selecting the integrated internet tile 370c (shown in FIG. 6). The internet application program codes may then cause the microprocessor 250 to direct the display screen 106 to display a user interface of the internet browsing application for retrieving, presenting and accessing information resources on the World Wide Web or a secured internal network. For example, the internet application program codes may cause the microprocessor 250 to direct the display screen 106 to display the user interface of the internet browsing application in the television view area 272. Further, the internet application program codes may cause the microprocessor 250 to direct the external network interface 205 (such as the antenna 130a, the wired ports 132b and the telephone line jack 134 ((shown in FIG. 2), for example) components of the AIO television 100 to enable the AIO television 100 to communicate with a service provider, such as the internet service provider 202a, over the external network 204, such as a LAN network, for example, to facilitate access to the information resources.

One of the integrated device program codes 380 may be printer program codes, which includes codes for directing the microprocessor 250 to enable the AIO television 100 to perform integrated printing functions, such as making a physical representation of an image or a document displayed by the AIO television 100 using the integrated printer 122. For example, a user may initiate the printing program codes bock by selecting the integrated printer tile 370d (shown in FIG. 6), which may cause the microprocessor 250 to direct the integrated printer 122 of the AIO television 100 to print a representation of an image or a document displayed on the AIO television 100, such as at the television viewing area 272, for example.

One of the integrated device program codes 380 may be scanner program codes, which includes codes for directing the microprocessor 250 to enable the AIO television 100 to perform integrated scanning functions, such as optically scanning physical images and documents and converting it into a digital format, using the integrated scanner and copier 124. For example, a user may insert a physical document into the integrated scanner and copier 124 of the AIO television 100 and then may initiate the scanner program codes by selecting the integrated scanner tile 370e (shown in FIG. 6), which may cause the microprocessor 250 to direct the integrated scanner and copier 124 to scan the inserted physical document into a digital format. In some embodiments, the scanner program codes may further cause the microprocessor 250 to direct the scanned document in the digital format to be saved as a digital file and be stored in the storage memory 256.

One of the integrated device program codes 380 may be copier program codes, which includes codes for directing the microprocessor 250 to cause the AIO television 100 to perform intergrated copying functions, such as making physical copies of physical documents using the integrated scanner and copier 124. For example, a user may insert a physical document into the integrated scanner and copier 124 of the AIO television 100 and then may initiate the copier program codes by selecting an integrated copier tile of the integrated functionality tiles 370 displayed in the dashboard 280. The copier program codes may then cause the microprocessor 250 to direct the integrated scanner and copier 124 to copy the inserted physical document into at least one corresponding copied physical document.

One of the integrated device program codes 380 may be fax program codes, which includes codes for directing the microprocessor 250 to cause the AIO television 100 to perform integrated faxing functions, such as initiating and receiving fax transmissions of a physical document, using the integrated scanner and copier 124. For example, a user may insert a physical document into the integrated scanner and copier 124 of the AIO television 100 and then may initiate the faxing program codes by selecting an integrated fax tile of the integrated functionality tiles 370 displayed in the dashboard 280. The faxing program codes may then cause the microprocessor 250 to direct the integrated scanner and copier 124 to scan the physical document into a digital format and convert the digital format into a converted format which may be transmitted through a telephone external network, such as bitmap, for example. The faxing program codes may then cause the microprocessor 250 cause the document in the converted format to be transmitted through the external network 204 to a receiving fax machine, for example.

One of the integrated device program codes 380 may be media application program codes which includes codes for directing the microprocessor 250 to cause the AIO television 100 to run a media application installed in the program memory 254 and configured to enable the AIO television 100 to play multimedia files, such as audio files or video files. For example, a user may initiate the media program codes by selecting an integrated media tile of the integrated functionality tiles 370 displayed in the dashboard 280. The media program codes may cause the microprocessor 250 to direct the display screen 106 to display a user interface of the media application for playing and recording multimedia files, for example. The multimedia files may be stored in the storage memory 256 of the AIO television 100, for example, or may be received from a service provider 202 through the external network interface 205 of the AIO television 100. Upon user selection of a particular multimedia file, the media program codes may cause the microprocessor 250 to direct the display screen 106 and speaker 110 to project video portions and audio portions of the multimedia file to the user.

One of the integrated device program codes 380 may be lighting program codes, which includes codes for directing the microprocessor 250 enable the AIO television 100 to perform integrated lighting functionalities. For example, the lighting program codes may direct the microprocessor 250 to cause the display screen 106 of the AIO television 100 to function as a light source and to enable the control of the integrated lighting devices 115. A user may initiate the lighting program codes by selecting an integrated lighting tile of the integrated functionality tiles displayed in the dashboard 280. In some embodiments, the lighting program codes may cause the microprocessor 250 to direct the display screen 106 to display light of a specific colour and brightness. In some embodiments, the lighting program codes may cause the microprocessor 250 to direct the integrated lighting devices 115 of the AIO television 100 display light of a specific colour and brightness. In some embodiments, the lighting program codes may cause the microprocessor 250 to rotate the integrated lighting devices 115 relative to the frame 104 to produce light beams which are directed to a specific area. In some embodiments, the lighting program codes may further cause the microprocessor 250 to direct the integrated speaker 110 to emit audio, such as music, for example, which may be synchronized with the colour, brightness and direction of the integrated lighting devices 115. The audio may be retrieved from audio files stored in the storage memory 260, for example.

One of the integrated device program codes 380 may be camera application program codes which include codes which enable the AIO television 100 to perform integrated image capture functionalities using the integrated image capture device 114. For example, the camera application program codes may include codes for directing the microprocessor 250 to cause the AIO television 100 to run a camera application installed in the program memory 254 and configured to enable the AIO television 100 to record and capture images using the integrated image capture device 114. For example, a user may initiate the camera program codes by selecting an integrated camera tile of the integrated functionality tiles 370 displayed in the dashboard 280. The camera program codes may cause the microprocessor 250 to direct the display screen 106 to display a user interface of the camera application for capturing and recording images using the integrated image capture device 114, the integrated flash 116 and the integrated range finding device 118, for example. In some embodiments, the camera application program codes may include codes for directing the microprocessor 250 to apply photography filters to the captured images, enabling the user to capture and save images in black and white, for example. In some embodiments, the camera application program codes may include codes for directing the microprocessor 250 to apply pre-set options to the integrated image capture device 114, the integrated flash 116 and the integrated range finding device 118, enabling the user to capture and save images in “a portrait pre-set option” or “a passport pre-set option”, for example. In embodiments where the integrated image capture device 114 of the AIO television 100 is mounted on the rotating means, the camera application program codes may further include codes for directing the microprocessor 250 to cause the integrated image capture device 114 to rotate, enabling the user to capture and save 360° photographs, for example.

One of the integrated device program codes 380 may be integrated thermostat program codes, which includes codes for directing the microprocessor 250 to enable the AIO television 100 to perform integrated home temperature control functions, such as directly communicating and controlling operation of at least one heating device and at least one cooling device of the home through the internal network interface 209, for example. Additionally, the integrated thermostat program codes may further direct electric thermometer hardware components directly integrated into the AIO television 100 to measure a temperature of the home, for example. In various embodiments, the integrated home temperature control functions of the AIO television 100 include receiving and transmitting information signals from the at least one heating device and the at least one cooling device, transmitting command requests to control the operation of the at least one heating device, receiving input signals from a user indicating a desired temperature for a home, measuring a current temperature of a home, and displaying a current temperature of a home.

One of the integrated device program codes 380 may be integrated alarm program codes, which includes codes for directing the microprocessor 250 to enable the AIO television 100 function as an alarm control device and to perform integrated alarm functionalities, such as communicate with sensing means placed around a perimeter of the home and inside the home, be armed and disarmed, and provide an alert, for example. For example, the AIO television 100 may be in constant or intermittent communication with sensor devices located throughout the home 210 through the internal network interface 209. In some embodiments, AIO television 100 may receive a breach signal from at least one of the sensor devices, which may cause the integrated alarm program codes to cause the microprocessor 250 to run an alarm application installed in the program memory 254 to enable the AIO television 100 to function as the alarm control device. For example, the integrated alarm program codes may cause the AIO television 100 to direct an alarm to be emitted through the integrated speaker 110 and direct an alarm interface be displayed on the display screen 106, for example. If a user does not actuate the alarm interface on the display screen 106 to disarm the AIO television 100, in some embodiments, the integrated alarm program codes may cause the AIO television 100 to make an emergency communication, such as cause a 911 telephone call transmitted through the external network interface 205, for example, to communicate an intrusion into the home. In various embodiments, the integrated alarm functionalities of the AIO television 100 include: receiving and transmitting information signals from at least one sensor device, at least one security camera external to the AIO television 100 and at least one audio intercom external to the AIO television 100; transmitting command requests to control the operation of the at least one sensor device, the at least one security camera, and the at least one audio intercom; emitting an alarm through the integrated speaker 110; displaying an alarm interface for arming and disarming the AIO television 100; and transmitting communications to external service providers.

In other embodiments, the integrated device program codes 380 may include codes for implementing other functionality of other various hardware components integrated directly on the AIO television 100.

Referring to back to FIG. 5, the program memory 254 may further store any other software applications to direct the microprocessor 250 to perform common computer functionalities. For example, the program memory 254 may store software applications including word processing applications, spreadsheet applications, presentation applications, anti-virus applications, anti-malware applications, information applications (such as accounting software and financial software, for example), entertainment applications (such as personal computer games, for example), etc.

Generally, the disclosed AIO device is configurable to incorporate the functionality of a variety of different hardware components within a single device. In some embodiments, the disclosed AIO device may contain sufficient different hardware components such that the disclosed AIO device may be only consumer device required in a home of the user. Further, the disclosed AIO device is configurable to incorporate the functionality of a control center for controlling a variety of different home devices using a single device. Further still, the disclosed AIO device is configurable to incorporate the functionality provided by a variety of different software applications installed in a single device.

While specific embodiments of the invention have been described and illustrated, such embodiments should be considered illustrative of the invention only and not as limiting the invention as construed in accordance with the accompanying claims.

What is claimed is:

1) An all-in-one device comprising:
a) a plurality of hardware components integrated directly into the all-in-one device,
b) the plurality of hardware components comprising:
i) television hardware components configured to perform at least one television functionality; and
ii) consumer device hardware components configured to perform at least one consumer device functionality, wherein the at least one consumer device functionality is different from the at least one television functionality;
c) at least one processor configured to, at least, direct the television hardware components to perform the at least one television functionality and the consumer device hardware components to perform the at least one consumer device functionality such that both the at least one television functionality and the consumer device functionality is performed directly by the all-in-one device.

2) The all-in-one device of claim 1, wherein the at least one processor is configured to direct the consumer device hardware components to perform the at least one consumer device functionality at the same time as the at least one processor directs the television hardware components to perform the at least one television functionality.

3) The all-in-one device of claim 1, wherein the consumer device hardware components comprise hardware components of a printer integrated into the all-in-one device and wherein the consumer device functionality comprises integrated printing functionalities.

4) The all-in-one device of claim 1, wherein the consumer device components comprise hardware components of a telephone integrated into the all-in-one device and wherein the consumer device functionality comprises integrated telephone functionalities.

5) The all-in-one device of claim 1, wherein the consumer device components comprise hardware components of a scanner integrated into the all-in-one device and wherein the consumer device functionality comprises integrated scanning functionalities.

6) The all-in-one device of claim 1, wherein the consumer device components comprise hardware components of a copier integrated into the all-in-one device and wherein the consumer device functionality comprises integrated copying functionalities.

7) The all-in-one device of claim 1, wherein the consumer device components comprise hardware components of an image capture device integrated into the all-in-one device and wherein the consumer device functionality comprises integrated image capture functionalities.

8) The all-in-one device of claim 1, wherein the consumer device components comprise hardware components of a lighting device integrated into the all-in-one device and wherein the consumer device functionality comprises integrated lighting functionalities.

9) The all-in-one device of claim 1, wherein the consumer device components comprise hardware components of a thermostat device and a thermometer device integrated into the all-in-one device and wherein the consumer device functionality comprises integrated home temperature control functionalities.

10) The all-in-one device of claim 1, wherein the consumer device components comprise hardware components of an alarm control device integrated into the all-in-one device and wherein the consumer device functionality comprises integrated alarm functionalities.

11) The all-in-one device of claim 1, further comprising:
a) at least one communication interface for communicating with a plurality of home devices connected to the all-in-one device; and
b) wherein the at least one processor is further configured to:
i) receive, from at least one input device of the all-in-one device, a user selection signal representing the user selection of a selected at least one home device of the plurality of home devices;
ii) retrieve information from the selected at least one home device; and
iii) display, on at least one display of the all-in-one device, the retrieved information from the selected at least one home device.

12) The all-in-one device of claim 11, wherein the at least one communication interface is integrated directly into the all-in-one device.

13) The all-in-one device of claim 11, wherein the at least one input device is integrated directly into the all-in-one device.

14) The all-in-one device of claim 11, wherein the plurality of home devices comprises a thermostat external to the all-in-one device.

15) The all-in-one device of claim 11, wherein the plurality of home devices comprises a security camera.

16) The all-in-one device of claim 11, wherein the plurality of home devices comprise an audio intercom.

17) The all-in-one device of claim 11, wherein the plurality of home devices comprise a home alarm system external to the all-in-one device.

18) The all-in-one device of claim 11, wherein the plurality of home devices comprises an oven.

19) The all-in-one device of claim 11, wherein the plurality of home devices comprises a microwave.

20) The all-in-one device of claim 11, wherein the plurality of home devices comprises a dishwasher.

21) The all-in-one device of claim 11, wherein the plurality of home devices comprises a clothing washer.

22) The all-in-one device of claim 11, wherein the plurality of home devices comprises a clothing dryer.

23) The all-in-one device of claim 11, wherein the plurality of home devices comprises a door controller.

24) The all-in-one device of claim 11, wherein the retrieved information comprises data information captured by the selected at least one home device.

25) The all-in-one device of claim 11, wherein the retrieved information comprises preset command options for controlling the selected at least one home device.

26) The all-in-one device of claim 25, wherein the at least one processor is further configured to: receive, from the at least one input device, a user input signal representing user actuation of at least one of the preset command options retrieved from the selected at least one home device; generate a command request in response to the user input signal; and transmit the command request to the selected at least one home device to cause the selected at least one home device to implement the command request.

27) The all-in-one device of claim 26, wherein the at least one processor is further configured to: receive a device output signal from the selected at least one home device, the device output signal representing an implementation of the transmitted command request by the selected at least one home device; and display, on the at least one display, a representation of the device output signal.
